(19) United States
(12) Patent Application Publication
(10) Pub. No.: US 2005/0055713 A1
(43) Pub. Date: Mar. 10, 2005

(54) Apparatus and method for sharing recommended programs using digital set-top boxes

(75) Inventors: Jung-bong Lee, Seoul (KR); Hyun-mi Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/936,526

(22) Filed: Sep. 9, 2004

(30) Foreign Application Priority Data
Sep. 9, 2003 (KR) 10-2003-0063351

(51) Int. Cl. H04N 7/16; G06F 3/00; H04N 7/10; H04N 7/025; H04H 9/00; G11B 7/00

(52) U.S. Cl. 725/46; 725/80; 725/14; 725/35; 725/34

(57) ABSTRACT

An apparatus and method for sharing recommended program information using set-top boxes are provided. The apparatus includes a plurality of set-top boxes capable of transmitting and receiving recommended program information and a server for generating a set-top box list for the plurality of set-top boxes. A user is provided with the recommended program information which is matched with the user's taste by making the plurality of set-top boxes a community through a network and then allowing users to recommend programs among the plurality of set-top boxes.

This application is based on, and claims priority from, Korean Patent Application No. 10-2003-0063351 filed on Sep. 9, 2003 in the Korean Intellectual Property Office, the disclosure of which is incorporated herein in its entirety by reference.

### BACKGROUND OF THE INVENTION

1. Field of the Invention

The present invention relates to an apparatus and method for sharing recommended program information using digital set-top boxes, and, more particularly, to an apparatus and method for sharing recommended program information using digital set-top boxes wherein broadcasting programs can be recommended among a plurality of set-top boxes which are connected with one another through a network.

2. Description of the Related Art

Generally, in digital broadcasting based on the MPEG standard, broadcasting programs corresponding to a plurality of channels are multiplexed and transmitted on a bit stream, and a broadcasting program signal corresponding to a channel which a user wishes to watch is separated from the transmitted bit stream, decoded and displayed on a television screen. In such a digital broadcasting, an electronic program guide (EPG) for the broadcasting programs in each channel or time is transmitted together with the bit stream, so that the user can easily search for his or her favorite broadcasting programs using the EPG.

Since the EPG includes information on time and titles of the broadcasting programs and detailed information on the corresponding broadcasting programs, the user can search for program information of his or her desired programs using the EPG which is displayed on the television screen.

Also, since it is possible to carry out a bidirectional communication function of the Internet by making a connection to a digital television, providing an Internet connection through a television is becoming widely used as Internet communication technology becomes more common.

That is, as shown in FIG. 1, the user can use additional functions together with the EPG, such as mail 10, buddy list 20 for transmitting messages within a desired user community, moving picture watching 30, and chatting 40 while watching the broadcasting programs.

On the other hand, as cable or satellite broadcasting is generalized, the number of channels which the user can watch, is increased and then the time required to search for broadcasting programs being broadcasted on the channels preferred by the user is also increased, so that the cable or satellite broadcasting program provider includes recommended program information in the EPG.

For example, referring to FIG. 2, recommended program information 60 is displayed on one side of an existing EPG 50.

Currently, the recommended program information 60 includes a still cut 61 and a program name 62 for the corresponding program, so that the user can carry out reservation recording and alarm recording using the recommended program information 60.

However, since such information on the recommended programs is displayed regardless of a user's preference, the user has to view the programs included in the recommended program information even when there is no desired program for the user in the recommended program information, and therefore the user is inconvenienced.

### SUMMARY OF THE INVENTION

An apparatus and method consistent with the present invention provide sharing of recommended program information using digital set-top boxes by allowing broadcasting programs to be recommended among a plurality of set-top boxes connected with one another through a desired network, so that broadcasting programs according to the user's preferences can be recommended to one another.

According to an exemplary embodiment of the present invention, there is provided a digital set-top box through which recommended program information received from a plurality of set-top boxes connected with one another through a desired network is displayed on a screen.

Preferably, but not necessarily, the recommended program information includes still cuts of the corresponding programs and additional information used to identify a set-top box which has transmitted the recommended program information. It is contemplated that the recommended program information may be received from an arbitrary set-top box connected through the network. The recommended program information may also be received from a plurality of set-top boxes and a server connected through a network. Preferably, but not necessarily, a set-top box list of the plurality of set-top boxes connected with one another through the network is received from the server.

It is further contemplated that, using the set-top box list, a set-top box to receive the recommended program information is selected and the recommended program information is transmitted to the selected set-top box.

According to an exemplary embodiment of the present invention, there is provided an apparatus for sharing recommended programs, comprising a transmission-side set-top box for transmitting recommended program information for broadcasting programs to be recommended; a server for being connected to a plurality of set-top boxes through a network and storing recommended program information transmitted from the transmission-side set-top box; and a reception-side set-top box for receiving recommended program information stored in the server and displaying the information on a screen.

Preferably, but not necessarily, the server calculates a recommended frequency for each program using the recommended program information, and generates information on additional recommended programs in accordance with the calculated results. It is further contemplated that the reception-side set-top box sorts programs to be received, and the server transmits the recommended program information matched to the sorting.

Preferably, but not necessarily, the server transmits information on the sorted programs to the transmission-side set-top box, and the transmission-side set-top box transmits the recommended program information matched to the sorting of the reception-side set-top box.

According to an exemplary embodiment of the present invention, there is provided a method for sharing recommended program information, comprising receiving recommended program information from at least one of a plurality of set-top boxes connected with one another through a desired network; and displaying the recommended program information on a screen.

The information reception may include a process for sorting programs to be received. Preferably, but not necessarily, the recommended program information is received from an arbitrary set-top box connected through the network. The recommended program information may be received from a server connected to a plurality of set-top boxes.

Preferably, but not necessarily, the information reception includes a process for receiving a set-top box list including a plurality of set-top boxes connected with one another through the network. It is additionally contemplated that a set-top box to receive the recommended program information is selected using the set-top box list.

According to an exemplary embodiment of the present invention, there is provided a method for sharing recommended programs, comprising transmitting recommended program information for programs to be recommended to an arbitrary set-top box, storing the recommended program information which has been transmitted, and receiving the recommended program information which has been stored and displaying the information on a screen.

Preferably, but not necessarily, the transmission further includes receiving a set-top box list including a plurality of set-top boxes connected with one another through a network; and selecting a desired set-top box using the set-top box list. The information storage may further include calculating a recommended frequency for each program using the recommended programs and generating separate recommended program information in accordance with the calculated results. The information reception may further include a process for sorting programs to be received.

### BRIEF DESCRIPTION OF THE DRAWINGS

The above and other aspects and features of the present invention will become more apparent by the following description of the illustrative, non-limiting embodiments thereof with reference to the accompanying drawings, in which:

FIG. 1 illustrates a menu for interactive communication while a broadcasting program is being displayed;

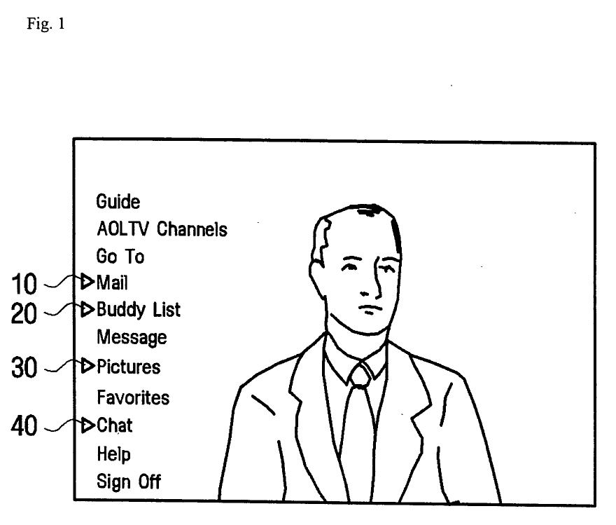

FIG. 2 illustrates an EPG including recommended program information;

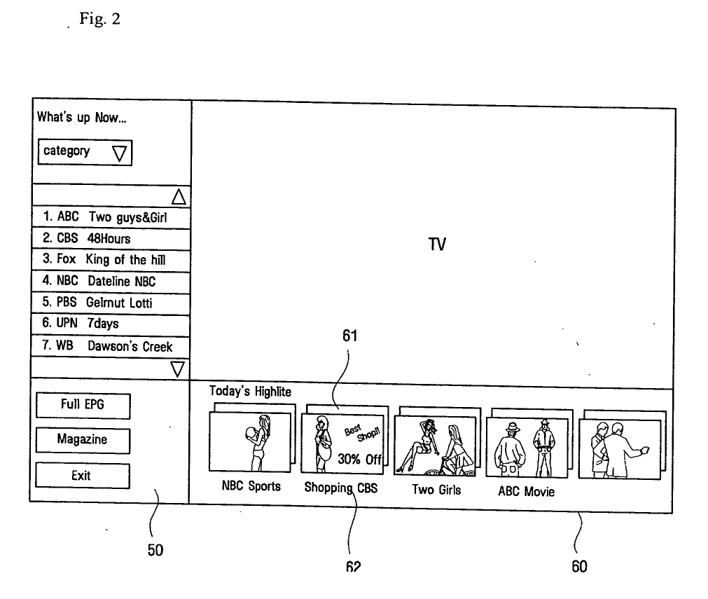

FIG. 3 is a block diagram of an apparatus for sharing recommended programs using a digital set-top box according to an exemplary embodiment of the present invention;

FIG. 4 is a flowchart of a method for transmitting recommended program information using a digital set-top box according to an exemplary embodiment of the present invention;

FIGS. 5a and 5b illustrate a screen for selecting a set-top box to which recommended program information is transmitted according to an exemplary embodiment of the present invention;

FIGS. 6a and 6b illustrate a screen for selecting a set-top box to which recommended program information is transmitted using an EPG according to an exemplary embodiment of the present invention;

FIG. 7 is a flowchart of a method for receiving recommended program information using a digital set-top box according to an exemplary embodiment of the present invention;

FIG. 8 illustrates recommended program information being displayed according to an exemplary embodiment of the present inventio; and

FIG. 9 illustrates recommended program information being displayed according to an exemplary embodiment of the present invention.

### DETAILED DESCRIPTION OF ILLUSTRATIVE, NON-LIMITING EMBODIMENTS OF THE INVENTION

An apparatus and a method for sharing recommended programs using digital set-top boxes according to illustrative, non-limiting embodiments of the present invention are described in detail with reference to the accompanying drawings.

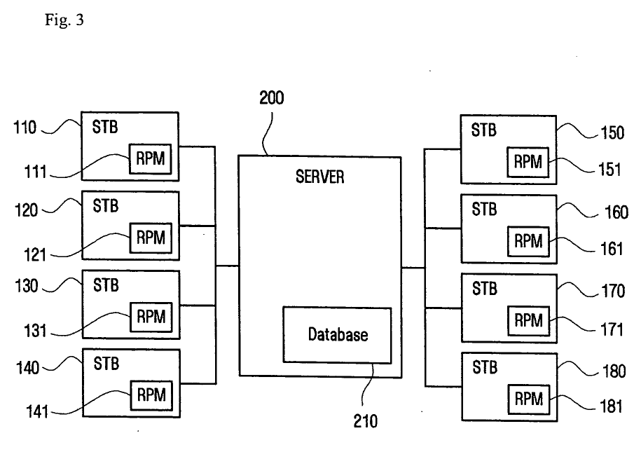

Referring to FIG. 3, the apparatus for sharing recommended program information according to an exemplary embodiment of the present invention includes a plurality of set-top boxes (labeled “STB”) 110, 120, 130, 140, 150, 160, 170, and 180 which perform transmission and reception of recommended programs, and a server 200 which is connected with the plurality of set-top boxes 110, 120, 130, 140, 150, 160, 170, and 180 through a network and generates a set-top box list including the plurality of set-top boxes 110, 120, 130, 140, 150, 160, 170, and 180.

Each of the plurality of set-top boxes 110, 120, 130, 140, 150, 160, 170, and 180 may receive recommended program information transmitted from different set-top boxes and also may transmit recommended program information to desired set-top boxes. The plurality of set-top boxes 110, 120, 130, 140, 150, 160, 170, and 180 may include Recommendation Program Managers (labeled “RPMs”) 111, 121, 131, 141, 151, 161, 171; and 181, as shown in FIG. 3. The RPMs manage general operations related to transmission and reception of recommended program information.

The server 200 generates a set-top box list including the plurality of set-top boxes 110, 120, 130, 140, 150, 160, 170, and 180, and the set-top box list includes unique information on each set-top box. The unique information may include a unique ID which the server 200 assigns or provides and/or a unique ID which cable, satellite, or public wave broadcasting providers assign or provide to each of the plurality of set-top boxes 110, 120, 130, 140, 150, 160, 170, and 180 provided with broadcasting services.

The server 200 transmits the set-top box list to the plurality of set-top boxes 110, 120, 130, 140, 150, 160, 170, and 180, and the plurality of set-top boxes 110, 120, 130, 140, 150, 160, 170, and 180 receive the set-top box list and display the set-top box list whenever requested by the user.

Using the set-top box list, a set-top box to which recommended program information is to be transmitted is selected by the user, and the recommended program information is transmitted to the selected set-top box. Recommended program information may include a still cut from the recommended program and/or additional information to make it possible to identify the set-top box which has transmitted the recommended program information. Such additional information may include a unique ID corresponding to each set-top box, a user's name, a user's photograph and/or an avatar. Thus, a set-top box user, who has received the recommended program information can easily identify the set-top box which transmitted the recommended program information. Also, the additional information may include a desired message input by the set-top box user who transmits the recommended program information.

Optionally, recommended program information can be transmitted and received not only among the plurality of set-top boxes 110, 120, 130, 140, 150, 160, 170, and 180 with one another directly, but also through the server 200. Recommended program information transmitted by an arbitrary set-top box can be transmitted to other set-top boxes directly, or can be transmitted to the server 200 to be transmitted to another set-top box from the server 200.

Also, the server 200 may include a database 210 to store recommended program information and calculate a recommended frequency for each program using the recommended program information stored in the database 210. In such case, the server 200 then generates separate recommended program information on the basis of the recommended frequency. The set-top box receiving the recommended program information can receive not only recommended program information generated by an arbitrary or chosen set-top box but also the separate recommended program information generated by the server 200.

Optionally, the set-top box receiving the recommended program information may sort information on desired programs to be received so that too much recommended program information is not received, and on this basis receives the recommended program information from the arbitrary or chosen set-top box or the server 200 according to the sorting of the desired program information.

Operation of an apparatus for sharing recommended program information in accordance with an illustrative, non-limiting embodiment of the present invention will now be described.

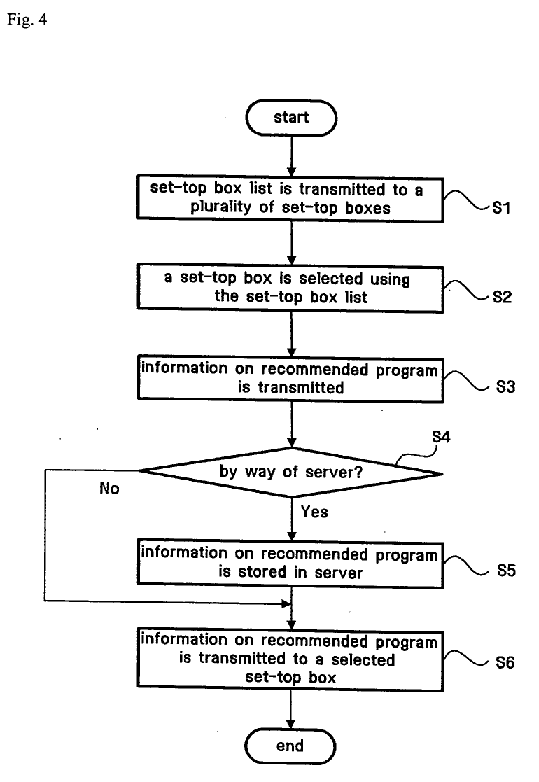

Referring to FIG. 4, a method for transmitting recommended program information in accordance with an illustrative, non-limiting embodiment of the present invention includes transmitting a set-top box list of a plurality of set-top boxes 110, 120, 130, 140, 150, 160, 170, and 180, which are connected with one another through a network via a server 200 to the plurality of set-top boxes (S1). Here, the set-top box list includes unique information of the plurality of set-top boxes 110, 120, 130, 140, 150, 160, 170 and 180 and of the server 200, both being connected to the network.

In a second step S2, an arbitrary or chosen set-top box selects a desired set-top box to which recommended program information is to be transmitted using the set-top box list previously transmitted.

In a third step S3, the recommended program information is transmitted to the selected set-top box. The recommended program information may include still cuts from the corresponding programs and additional information to identify the set-top box which has transmitted the recommended program information. Also, such additional information may include a unique ID to identify the set-top box, a user's name, a user's photograph, an avatar, and/or a desired message input by the user who transmitted the recommended program information.

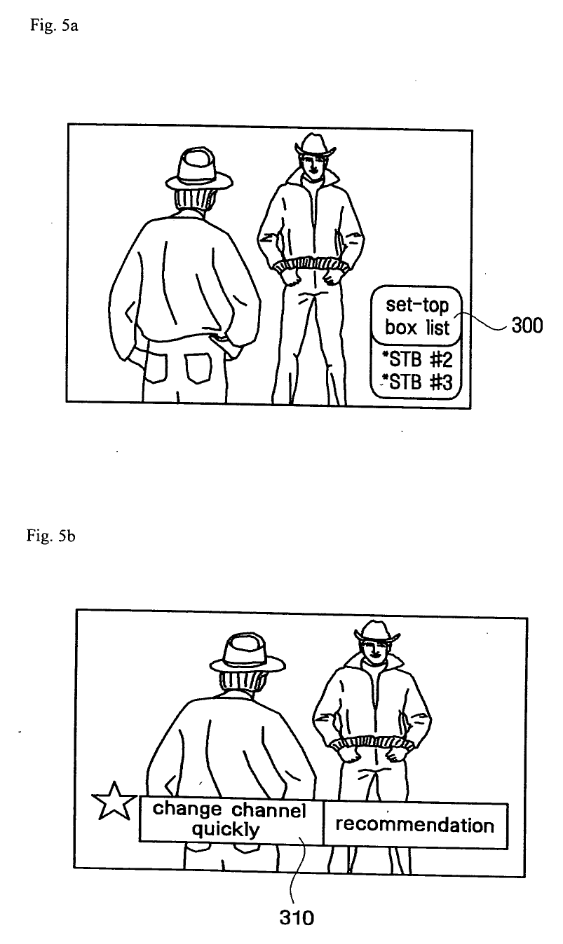

Referring to FIG. 5a, in an exemplary embodiment of the present invention, when a program which is being watched is recommended, an arbitrary set-top box can be selected by a user through a set-top box list 300 while the user is watching a program, and the recommended program information is then transmitted to the selected set-top box.

Also, referring to FIG. 5b, the set-top box user who is transmitting the recommended program information can input a desired message 310 to be transmitted together with the recommended program information.

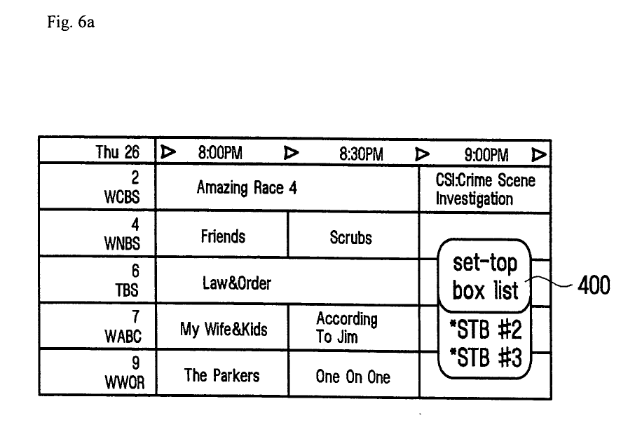

Also, as to transmission of recommended program information using an EPG; as shown in FIG. 6a, after an arbitrary program to recommend is selected using the EPG, an arbitrary set-top box is selected using a set-top box list 400. The recommended program information can then be transmitted to the selected set-top box.

Also, as shown in FIG. 6b, to the user may transmit a desired message 410 together with the recommended program information.

As shown in FIG. 4 in a fourth step S4, it is determined whether the recommended program information, which has been transmitted, is transmitted to the selected set-top box by way of the server 200.

In a fifth step S5, when the information on the recommended program, which has been transmitted, is transmitted by way of the server 200, the recommended program information which has been transmitted may be stored in the database 210 of the server 200.

In the fifth step S5, the server 200 may optionally calculate a recommended frequency for each program on the basis of the recommended program information which has been stored, and separate recommended program information may then be independently generated in accordance with the calculation results. The generated recommended program information may be helpful in obtaining information on various recommended programs from set-top boxes receiving recommended program information and may also be used effectively when there is no set-top box transmitting recommended program information.

In a sixth step S6, recommended program information stored in the server 200 may be transmitted to the selected set-top box from the server 200. However, when recommended program information is not transmitted by way of the server 200 as determined in the fourth step S4, the recommended program information is transmitted in S6 directly to the a selected set-top box from the sending set-top box.

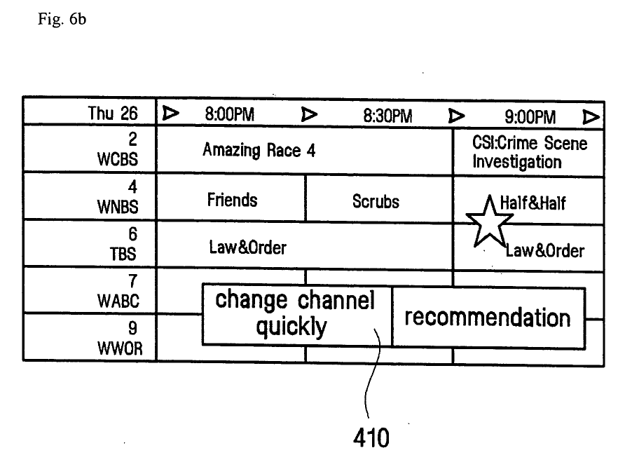

In FIG. 7, an illustrative, non-limiting method for receiving recommended program information by the receiving set-top box optionally includes an eleventh step S11 of sorting desired programs to be received. Too much information on the recommended programs might be received if the programs are not sorted. Also, the sorting process can reduce unnecessary time in searching for recommended program information which is required by a user. Also, when recommended program information is not required, it is possible for the receiving set-top box to interrupt the reception of recommended program information.

In a twelfth step S12, recommended program information in accordance with the desired program sorting is received. At this time, it is possible to receive recommended program information from an arbitrary set-top box directly or the recommended program information as separately generated by the server 200. The determination of such a source of the recommended program information which is received may optionally be chosen by the set-top box user receiving the recommended program information.

In a thirteenth step S13, the recommended program information is displayed on the screen.

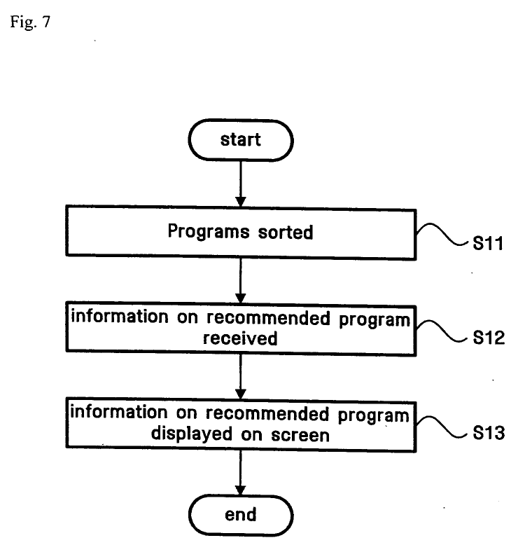

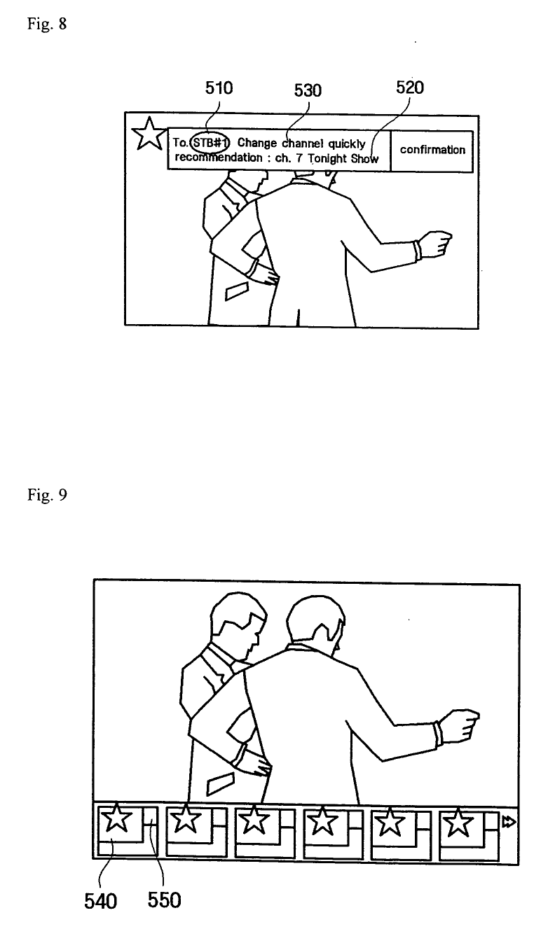

In an exemplary and non-limiting embodiment of the present invention, when the recommended program information is about a current broadcasting program, a unique ID 510 of the set-top box which has transmitted the recommended program information, program information 520, and/or a desired message 530 input by the transmitting set-top box user are displayed, as shown in FIG. 8. Also, when the recommended program information is not a current broadcasting program, a still cut 540 from the recommended program and/or an avatar 550 to identify the set-top box having transmitted the recommended program information may be displayed on the screen, as shown in FIG. 9.

Instead of an avatar, a unique ID, a user's name and/or a user's photograph from the transmitting set-top box may be displayed instead of the avatar. Accordingly, it is possible to perform reservation recording and alarm reservation through the still cut 540 and the avatar 550.

Although the exemplary embodiments of the present invention have been disclosed for illustrative purposes, those skilled in the art appreciate that various modifications, additions and/or substitutions are possible, without departing from the scope and spirit of the invention as disclosed in the accompanying claims.

In accordance with the present invention, an effect may be obtained that recommended program information can be provided, which is more fitted with a user's taste by making a community among a plurality of set-top boxes and then recommending programs among the plurality of set-top boxes with one another through a desired network.

1. An apparatus for sharing program information, comprising a set-top box through which recommended program information received from at least one of a plurality of set-top boxes connected with one another, through a desired network, is displayed on a screen.

2. The apparatus according to claim 1, wherein the recommended program information comprises still cuts of corresponding programs and additional information capable of identifying set-top boxes which have transmitted the recommended program information.

3. The apparatus according to claim 1, wherein the recommended program information is received from a server which is connected to the plurality of set-top boxes through a network.

4. The apparatus according to claim 3, wherein the first set-top box receives, from the server, a set-top box list comprising the plurality of set-top boxes connected with one another through the network.

5. The apparatus according to claim 4, wherein the first set-top box is selected using the set-top box list such that the first set-top box receives the recommended program information transmitted from at least one of the plurality of set-top boxes.

6. The apparatus according to claim 1, wherein the set-top box is a digital set-top box.

7. An apparatus for sharing recommended programs, comprising:
a transmission-side set-top box which transmits recommended program information pertaining to broadcast programs;
a server connected to a plurality of set-top boxes through a network to store the recommended program information transmitted from the transmission-side set-top box; and
a reception-side set-top box which receives the recommended program information stored in the server and displays the recommended program information on a screen.

8. The apparatus according to claim 7, wherein the recommended program information includes still cuts of the broadcast programs to be recommended and additional information to identify the transmission-side set-top box.

9. The apparatus according to claim 8, wherein the server generates a set-top box list including a plurality of set-top boxes connected with one another through a network and transmits the list to the plurality of set-top boxes.

10. The apparatus according to claim 9, wherein the transmission-side set-top box selects at least one of the plurality of set-top boxes to transmit the recommended program information to using the set-top box list.

11. The apparatus according to claim 9, wherein the server calculates a recommended frequency for each program using the recommended program information, and generates additional recommended program information in accordance with the calculated results.

12. The apparatus according to claim 11, wherein the reception-side set-top box sorts programs to be received, and the server transmits the recommended program information matched to the sorting.

13. The apparatus according to claim 12, wherein the server transmits information on the sorted programs to the transmission-side set-top box, and the transmission-side set-top box transmits the recommended program information matched to the sorting to the reception-side set-top box.

14. A method for sharing recommended program information, comprising:
receiving recommended program information from at least one of a plurality of set-top boxes connected with one another through a network; and
displaying the received recommended program information on a screen.

15. The method according to claim 14, wherein the recommended program information includes at least one of a still cut of the corresponding program and additional information to identify set-top boxes which have transmitted the recommended program information.

16. The method according to claim 15, wherein receiving recommended program information further comprises sorting programs to be received.

17. The method according to claim 16, wherein the recommended program information is received from a server connected to the plurality of set-top boxes.

18. The method according to claim 17, wherein the receiving recommended program information includes receiving from the server a set-top box list of the plurality of set-top boxes connected with one another.

19. The method according to claim 17, wherein the displaying the received recommended program information includes:
storing the recommended program information transmitted from the plurality of set-top boxes; and
calculating a recommended frequency for each program using the stored recommended program information and generating separate recommended program information in accordance with the calculation results.

20. The method according to claim 18, including selecting a set-top box to receive the recommended program information using the received set-top box list.

21. A method for sharing recommended program information, comprising:
transmitting the recommended program information to a set-top box;
storing the recommended program information which has been transmitted; and
receiving the recommended program information which has been stored and displaying the received recommended program information on a screen.

22. The method according to claim 21, wherein the recommended program information includes at least one of a still cut from a corresponding program and additional information used to identify a transmitting set-top box.

23. The method according to claim 22, wherein the method includes:
receiving a set-top box list including a plurality of set-top boxes connected with one another through a network; and
selecting a desired receiving set-top box using the set-top box list.

24. The method according to claim 22, wherein the storing recommended program information includes calculating a recommended frequency for each program using the recommended program information and generating separate recommended program information in accordance with the calculated results.

25. The method according to claim 22, wherein the receiving recommended program information includes sorting programs to be received.

26. An apparatus for providing recommended program information to a screen, comprising:
a plurality of set-top boxes, with each set-top box being associated with a screen; and
a network connecting the plurality of set-top boxes;
wherein at least one transmitting set-top box is adapted to transmit the recommended program information to at least one receiving set-top box through the network, and the recommended program information is displayed on the screen associated with the receiving set-top box.

27. The apparatus of claim 26, wherein the recommended program information includes at least one of a still cut of a recommended program and additional information capable of identifying the transmitting set-top box.

28. The apparatus of claim 26, including a server which is connected to at least two of the plurality of set-top boxes through the network and wherein the recommended program information is received from the server.

29. The apparatus of claim 26, including a set-top box list which lists the plurality of set-top boxes connected with one another through the network, and wherein the set-top box list is available to the plurality of set-top boxes through the server.

30. The apparatus of claim 29, wherein the receiving set-top box is selected using the set-top box list, and the recommended program information is transmitted to the receiving set-top box thereby selected.
